(19) United States
(12) Patent Application Publication
(10) Pub. No.: US 2005/0207596 A1
(43) Pub. Date: Sep. 22, 2005

(54) Packaged digital microphone device with auxiliary line-in function

(75) Inventors: Franco Enrico Beretta, Monza (IT); Paolo Gonella Pacchiotti, Milano (IT); Angelo Nagari, Cilavegna (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 11/058,800

(22) Filed: Feb. 16, 2005

(30) Foreign Application Priority Data
Feb. 16, 2004 (EP) 04425098.3

(51) Int. Cl. H04R 3/00; H04R 1/02; H04R 25/00

(52) U.S. Cl. 381/111; 381/91; 381/122; 381/115

(57) ABSTRACT

A digital microphone device outputs a digital audio signal to a digital signal processing system. The digital microphone device includes an acoustic transducer for producing an analog voltage signal representative of an acoustic signal, and an integrated circuit including an input multiplexer. The input multiplexer has a first analog input coupled to an output of the acoustic transducer, and a second analog input to be connected to an output of a remote external analog microphone providing an analog voltage signal. A variable gain analog signal pre-amplifier is coupled to an output of the input multiplexer.

### FIELD OF THE INVENTION

The present invention relates to transducers for converting sound, vibration and like signals to electrical signals for transmission, reproduction, recording or analysis, such as for microphones, pick-ups, and other audio transducers.

### BACKGROUND OF THE INVENTION

Transducers convert different forms of energy, such as light, sound, heat, pressure and motion to electrical signals. Generally, these devices generate some form of an analog electrical signal. This signal is typically a voltage or current signal that varies in accordance with the sensed physical quantity. Acoustic transducers or microphones are included in a large array of everyday use apparatuses, such as cellular phones, wireless handsets, headsets, portable PCs and other instruments of various kinds.

Generally, the low level electrical signal generated by transducers is either preamplified or applied to an impedance matching transformer to convert the signal to a suitable impedance level and voltage for transmission to digital processing circuitry. The preamplified or transformed electrical signal is generally conveyed through a cable or through internal wiring of the apparatus to an interface of a signal processor, as schematically illustrated in FIG. 1.

The increasing success in digital processing of audio signals is prompted by the augmented ability of integrating digital functions by modern VLSI and ULSI fabrication technologies of integrated circuits that has made possible the translation of many analog functions into digital processing. In sound reproduction systems, equalizations based on filtering the input signal, surround effects, reverberations and echoes are all implementable with a significantly enhanced quality through digital processing.

Sub-micrometer manufacturing processes have made available low cost powerful circuits for converting analog signals to digital signals and vice-versa. In this new context of pervasive adoption of digital processing techniques, it has been found advantageous to convey audio signals produced by a microphone to the audio signal processing unit after already having been converted into a digital format.

This has been accomplished by economically fabricating digital microphone devices in a single package (commonly a 4-pin device). The single package includes a conventional transducer, such as a crystal or electrostatic microphone, for example, and an integrated circuit usually including a constant bias generator for a biasing circuit or line in the acoustic transducer. The packaged microphone device also includes a variable gain preamplifier for boosting the analog audio signal produced by the transducer, and an analog-to-digital converter (ADC) for producing a digital output signal to be transmitted to the digital signal processing system of the apparatus. Because of these characteristics, the packaged microphone device is commonly referred to as a digital microphone.

The analog-to-digital converter (ADC) may be a sigma-delta converter or another equivalent converting circuit functioning at a sampling (clock) frequency on the order of hundreds of kilohertz. FIGS. 2A, 2B and 2C illustrate a typical digital microphone as commercially available.

U.S. Pat. No. 5,051,799 to Paul et al. discloses a digital microphone that is relatively low cost, lightweight, and is relatively free from noise and distortion. U.S. Pat. No. 5,886,656 is assigned to the current assignee of the present invention and is incorporated herein by reference in its entirety, and discloses a microphone device that addresses the problems that typically occur with an analog transmission.

While the use of digital microphones is becoming the norm in portable apparatuses like cellular phones, portable PCs and the like, they are normally installed within the casing of the portable apparatuses. Their utilization as auxiliary external microphones to be deployed at a distance from the apparatus containing the digital signal processing system may be problematic because of EMI and crosstalk. This is in view of the fact that the relatively long external cable connection of an external digital microphone to the apparatus carries digital signals of relatively high frequency. The digital signals include the sampling clock and the pulse modulated digitally converted audio signal output by the digital microphone device.

In many portable equipments such as mobile phones or PDAs, a headset jack if often available that supports the connection of a second or auxiliary external microphone embedded in the headset to permit handless use for the voice communication equipment.

In the common case of an internal digital microphone device MIC1 (the default one), and because of the above discussed problems and requisites for a cost effective production, the use of an auxiliary analog microphone MIC2 to be connected with a relatively long external cable is often contemplated.

To support such an auxiliary analog microphone, there is the need to include an additional ADC (in the Mixed-Signal chip, for example) to allow its connection within the DSP. The use of an internal digital microphone device (MIC1) renders the implementation of an analog in-line auxiliary input functionality relatively expensive because of the additional ADC and external components that are required.

### SUMMARY OF THE INVENTION

In view of the foregoing background, the drawback of using embedded digital microphones in electronic apparatuses is overcome based upon an architecture of a digital microphone to be embedded in an apparatus comprising an auxiliary line-in terminal or terminals in the packaged digital microphone device to which a remote analog microphone may be connected.

The use of an external (remote) analog microphone does not require a dedicated additional analog-to-digital converter. Such a line-in function of the packaged digital microphone device in accordance with the present invention may be duplicated for more than one external analog microphone.

More particularly, the packaged digital microphone device contains an analog transducer and the co-packaged integrated circuit includes an input signal multiplexer. The multiplexer handles the analog input signal generated by the acoustic transducer included in the package, and also analog signals generated by one or more auxiliary external microphones connected by a cable to a respective line-in jack or similar connection.

### BRIEF DESCRIPTION OF THE DRAWINGS

FIG. 1 is a functional block diagram of an audio system of an electronic apparatus with digital conversion of the analog transducer signal to a digital audio signal transmitted to a digital signal processor according to the prior art.

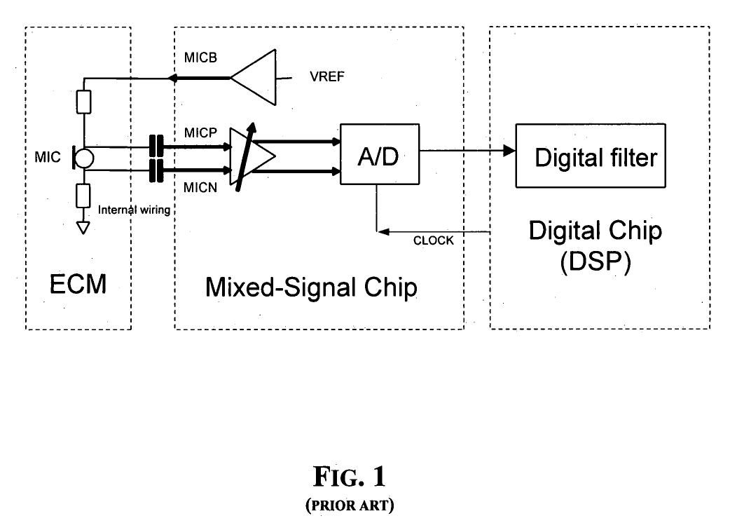

FIGS. 2A, 2B and 2C illustrate a packaged digital microphone device according to the prior art.

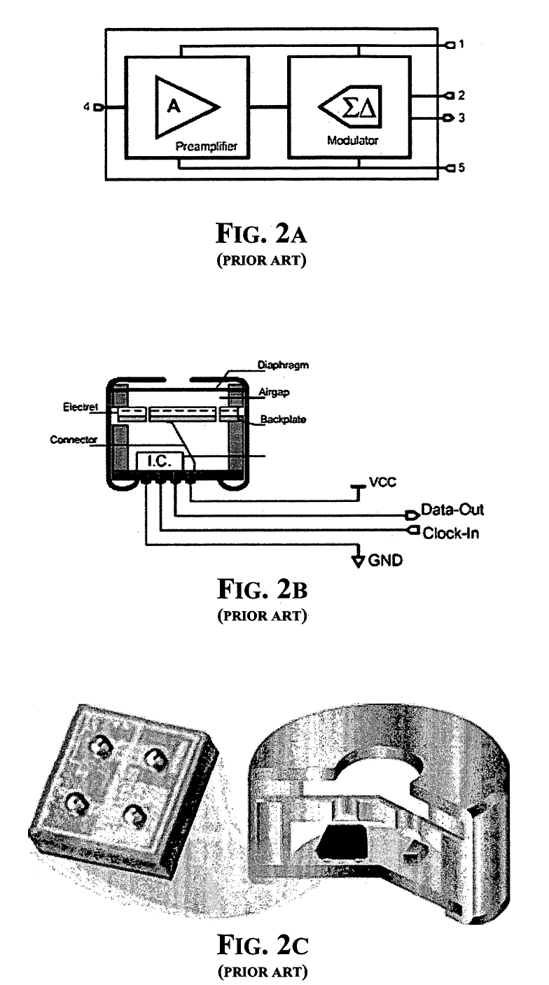

FIG. 3 shows the audio system of FIG. 1 with an embedded digital microphone plus an analog auxiliary microphone connected via an external cable, and which requires an additional ADC.

FIG. 4 illustrates a packaged digital microphone device according to the present invention.

FIG. 5 illustrates an alternative embodiment of the package digital microphone device according to the present invention.

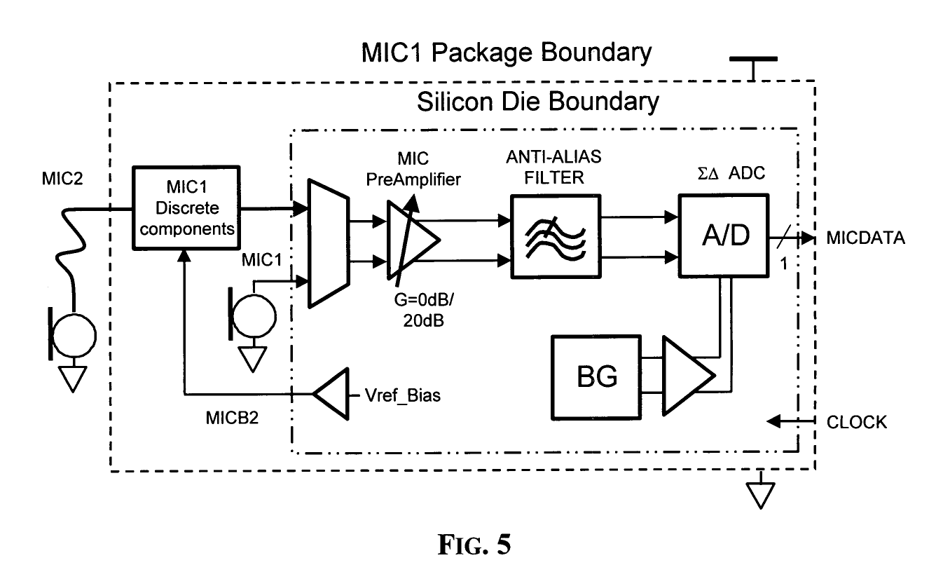

### DETAILED DESCRIPTION OF THE PREFERRED EMBODIMENTS

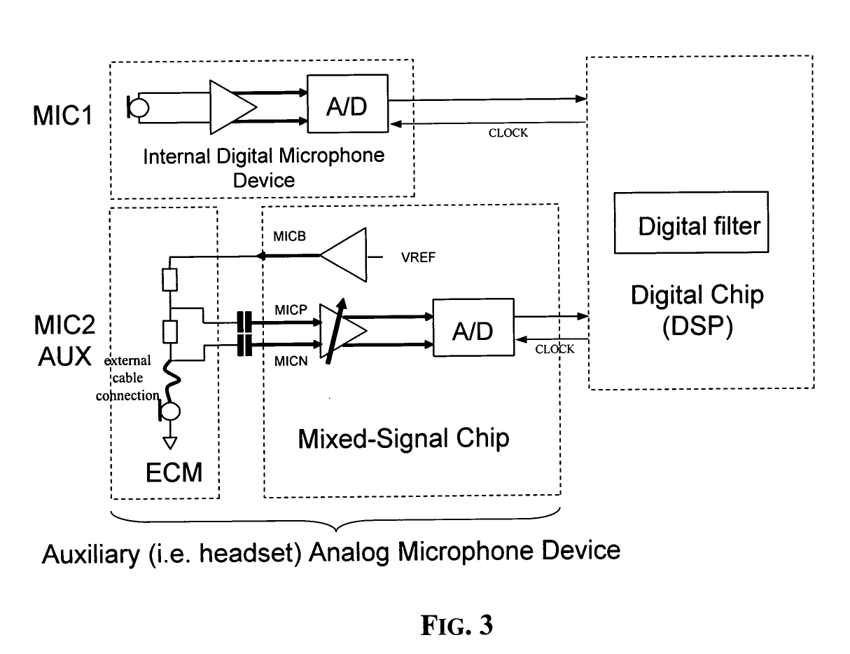

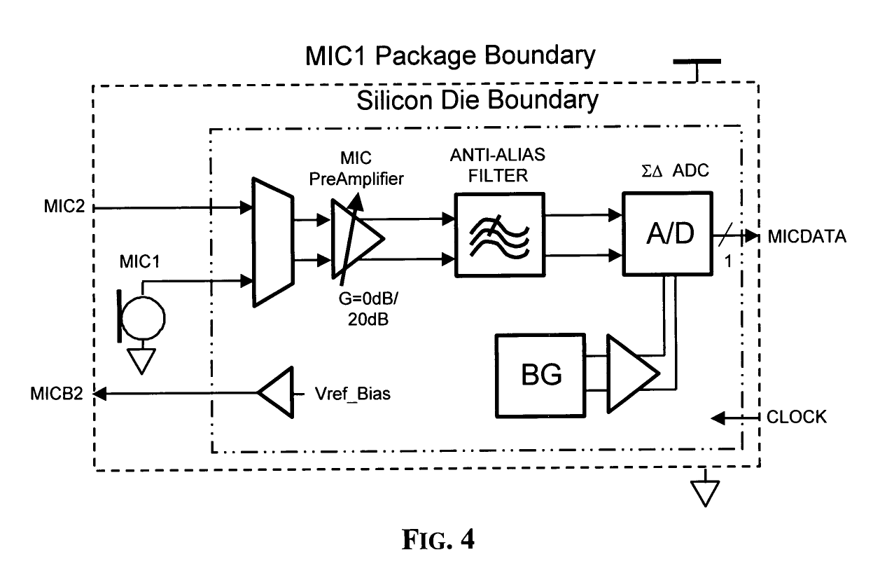

The digital microphone device in accordance with the invention is depicted in FIG. 4. Differently from the known device of FIG. 3, it does not require an additional analog-to-digital converter. It uses the same converter for both the internal microphone MIC1, and the analog audio signal coming from an external microphone MIC2AUX.

An input multiplexer selects one of the two audio signals and outputs the selected signal to a pre-amplifier stage. The amplified analog audio signal is filtered by an anti-aliasing filter, and is converted to a digital output MICDATA by a sigma-delta converter. The voltage reference is generated by a band-gap voltage generator BG.

This device also comprises a single-ended bias voltage for providing a bias voltage for the line-in microphone, and detection circuitry (not shown) to determine which microphone is being used. Usually the integrated ECM (Electret Condenser Microphone), which is generally set by default, is excluded when a headset is connected. In this case, the external audio signal MIC2 is automatically selected by the multiplexer to be converted by the analog-to-digital converter.

To avoid the need of a power-up bit, the microphone device of the invention has an automatic clock detection circuit (not shown). The automatic clock detection circuit powers up the device as soon as a clock signal is detected.

By comparing the known device of FIG. 3 and the device of FIG. 4, the device in accordance with the invention requires six pins, which is two pins more than the device of FIG. 4, for allowing the use of an external analog microphone. This device is more convenient to form because it needs a single A/D converter instead of two.

Moreover, the audio signals generated by the external microphone MIC2 and processed by the A/D converter are analog signals. That is, they are at a relatively low frequency. This ensures reduced EMI effects even if the microphone MIC2 is connected to the device through a relatively long cable.

To further reduce the number of pins, it is possible to integrate by using the so-called IPAD technology, for example, all the discrete components of the analog microphone MIC2 in the same package. This reduces the BOM (Bill of Material) impact on the costs of the packaged device.

1-2. (canceled)

3. A digital microphone device for outputting a digital audio signal to a digital signal processing system, and comprising:
an acoustic transducer for providing a first analog voltage signal representative of an acoustic signal; and
an integrated circuit comprising
an input multiplexer having a first analog input coupled to an output of said acoustic transducer, and at least one second analog input to be coupled to an output of a remote external analog microphone providing a second analog voltage signal, and
a variable gain analog signal pre-amplifier coupled to an output of said input multiplexer.

4. A digital microphone device according to claim 3 wherein said integrated circuit further comprises a bias voltage generator having an output to be coupled to the remote external analog microphone.

5. A digital microphone device according to claim 3 wherein said integrated circuit further comprises:
an anti-aliasing filter coupled to an output of said variable gain analog signal pre-amplifier; and
an analog-to-digital converter coupled to an output of said anti-aliasing filter, and having an output for providing the digital audio signal.

6. A digital microphone device for outputting a digital audio signal to a digital signal processing system, and comprising:
an acoustic transducer for providing a first analog voltage signal;
at least one discrete component to be connected to an output of a remote external analog microphone providing a analog voltage signal; and
an integrated circuit comprising
an input multiplexer having a first analog input coupled to an output of said acoustic transducer for receiving the first analog voltage signal, and at least one second analog input coupled to said at least one discrete component for receiving the second analog voltage signal, and
a variable gain analog signal pre-amplifier coupled to an output of said input multiplexer.

7. A digital microphone device according to claim 6 wherein said integrated circuit further comprises a bias voltage generator having an output coupled to said at least one discrete component.

8. A digital microphone device according to claim 6 wherein said integrated circuit further comprises:
an anti-aliasing filter coupled to an output of said variable gain analog signal pre-amplifier; and
an analog-to-digital converter coupled to an output of said anti-aliasing filter, and having an output for providing the digital audio signal.

9. An electrical apparatus comprising: a digital microphone device comprising
an acoustic transducer for providing a first analog voltage signal,
an integrated circuit comprising
an input multiplexer having a first analog input coupled to an output of said acoustic transducer, and at least one second analog input to be connected to an output of a remote external analog microphone providing a second analog voltage signal,
a variable gain analog signal pre-amplifier coupled to an output of said input multiplexer, and
an analog-to-digital converter coupled to an output of said variable gain analog signal pre-amplifier, and having an output for providing a digital audio signal; and
a digital signal processor having an input for receiving the digital audio signal.

10. An electrical apparatus according to claim 9 wherein said integrated circuit further comprises a bias voltage generator having an output to be connected to the remote external analog microphone.

11. An electrical apparatus according to claim 9 wherein said integrated circuit further comprises an anti-aliasing filter coupled between said variable gain analog signal pre-amplifier and said analog-to-digital converter.

12. A method for outputting a digital audio signal to a digital signal processing system using a digital microphone device, the method comprising:
producing a first analog voltage signal using an internal acoustic transducer;
producing a second analog voltage signal using an external acoustic transducer;
coupling the first analog voltage signal to a first input of an input multiplexer, and the second analog voltage signal to at least one second analog input of the input multiplexer; and
amplifying an output of the input multiplexer.

13. A method according to claim 12 further comprising generating a bias voltage for the remote external analog microphone.

14. A method according to claim 12 further comprising:
filtering an analog output of the variable gain analog signal pre-amplifier; and
converting the analog output of the anti-aliasing filter to the digital audio signal for the digital signal processing system.
